(19) United States
(12) Patent Application Publication
(10) Pub. No.: US 2008/0254843 A1
(43) Pub. Date: Oct. 16, 2008

(54) Electronic device having different use positions

(75) Inventor: Jani C. Maenpaa, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/786,661

(22) Filed: Apr. 12, 2007

(51) Int. Cl. H04M 1/02

(52) U.S. Cl. 455/575.3; 439/31

(57) ABSTRACT

Disclosed herein is a portable electronic device. The portable electronic device includes a housing and electronic circuitry. The housing includes a plurality of housing sections and the electronic circuitry is mounted in the housing. The plurality of housing sections are adapted to be re-oriented relative to each other into at least four different positions. Each of the at least four different positions is adapted to provide a different mode of use.

### BACKGROUND OF THE INVENTION

1. Field of the Invention

The exemplary embodiments of this invention relate to an electronic device and, more particularly, to an electronic device having different use positions.

2. Brief Description of Prior Developments

As electronic devices continue to become more sophisticated, these devices provide an increasing amount of functionality by including such applications as, for example, a mobile phone, digital camera, video camera, television, navigation system, gaming, personal organizer or PDA, and internet browser applications.

Electronic devices having more than one configuration are known in the art. For example, U.S. Pat. No. 6,728,557 discloses a multi-configuration portable electronic device having two body halves. As consumers demand increased functionality from electronic devices, there is a need to provide improved devices having increased capabilities while maintaining robust and reliable product configurations. Additionally, due to the demand for miniaturized devices, the increased capabilities should be provided in a compact yet user-friendly design.

Accordingly, there is a desire to provide an improved electronic device having different use positions.

### SUMMARY OF THE INVENTION

In accordance with one aspect of the exemplary embodiment of this invention, a portable electronic device is disclosed. The portable electronic device includes a housing and electronic circuitry. The housing includes a plurality of housing sections, and the electronic circuitry is mounted in the housing. The plurality of housing sections are adapted to be re-oriented relative to each other into at least four different positions. Each of the at least four different positions is adapted to provide a different mode of use.

In accordance with another aspect of the exemplary embodiment of this invention, a device housing is disclosed. The device housing includes a first housing assembly, a second housing assembly, and a third housing assembly. The second housing assembly is pivotably connected to the first housing assembly. The third housing assembly is pivotably connected to the first housing assembly. The housing assemblies are pivotable about parallel axes. The housing assemblies are pivotable into at least four different use orientations.

In accordance with another aspect of the exemplary embodiment of this invention, a portable electronic device is disclosed. The portable electronic device includes a first housing assembly, a second housing assembly, and a third housing assembly. The first housing assembly includes electronic circuitry. The second housing assembly is movably connected to the first housing assembly by a first hinge. The second housing assembly is movable about the first housing assembly between a first use position and a second use position relative to the first and the second housing assemblies. The third housing assembly is movably connected to the first housing assembly by a second hinge. The third housing assembly is movable about the first housing assembly between a first use position and a second use position relative to the first and the third housing assemblies.

In accordance with another aspect of the exemplary embodiment of this invention, a portable electronic device is disclosed. The portable electronic device includes a housing and electronic circuitry. The housing includes a first housing section, a second housing section, and a third housing section. The electronic circuitry mounted in the housing. The first housing section includes a first side, a second side, a third side, and a fourth side. The portable electronic device is configured to operate in a first use mode when the second housing section is adjacent to the first side and the third housing section is adjacent to the third side. The portable electronic device is configured to operate in a second use mode when the second housing section is adjacent to the fourth side and the third housing section is adjacent to the second side. The portable electronic device is configured to operate in a third use mode when the second housing section is adjacent to the first side and the third housing section is adjacent to the second side. The portable electronic device is configured to operate in a fourth use mode when the second housing section is adjacent to the fourth side and the third housing section is adjacent to the third side.

In accordance with another aspect of the exemplary embodiment of this invention, a method of manufacturing a portable electronic device is disclosed. A first housing section is provided. A first vertical hinge is attached to the first housing section. A second vertical hinge is attached to the first housing section. A second housing section is attached to the first housing section at the first vertical hinge. A third housing section is attached to the first housing section at the second vertical hinge. Electronic circuitry is installable within at least one of the housing sections.

In accordance with another aspect of the exemplary embodiment of this invention, a program storage device readable by a machine, tangibly embodying a program of instructions executable by the machine for performing operations to operate in one of at least four modes based on reconfiguration of the housing. Different operating modes are assigned to different configurations of the housing. The configuration of the housing is sensed. A display and user inputs are enabled to operate in accordance to the operating mode. One of at least four operating modes is changed to another one of the at least four operating modes in response to reconfiguration of the housing.

### BRIEF DESCRIPTION OF THE DRAWINGS

The foregoing aspects and other features of the exemplary embodiment of this invention are explained in the following description, taken in connection with the accompanying drawings, wherein:

FIG. 1 is a perspective view of an electronic device comprising features of the invention, wherein the device is oriented in a phone mode.

FIG. 2 is a perspective view of a first vertical hinge used in the electronic device shown in FIG. 1;

FIG. 3 is a perspective view of a second vertical hinge used in the electronic device shown in FIG. 1;

FIG. 4 is a perspective view of the electronic device of FIG. 1 oriented in a wide screen mode;

FIG. 5 is a perspective view of the electronic device of FIG. 1 oriented in a game mode;

FIG. 6 is a perspective view of the electronic device of FIG. 1 oriented in a fourth mode;

FIG. 7 is a perspective view of an alternative electronic device oriented in a phone mode;

FIG. 8 is a perspective view of the alternative electronic device of FIG. 7 oriented in a wide screen mode;

FIG. 9 is a perspective view of the alternative electronic device of FIG. 7 oriented in a game mode;

FIG. 10 is a perspective view of the alternative electronic device of FIG. 7 oriented in a fourth mode; and

FIG. 11 is a schematic diagram illustrating components of hand-held portable electronic devices shown in FIGS. 1 and 7.

### DETAILED DESCRIPTION OF THE PREFERRED EMBODIMENTS

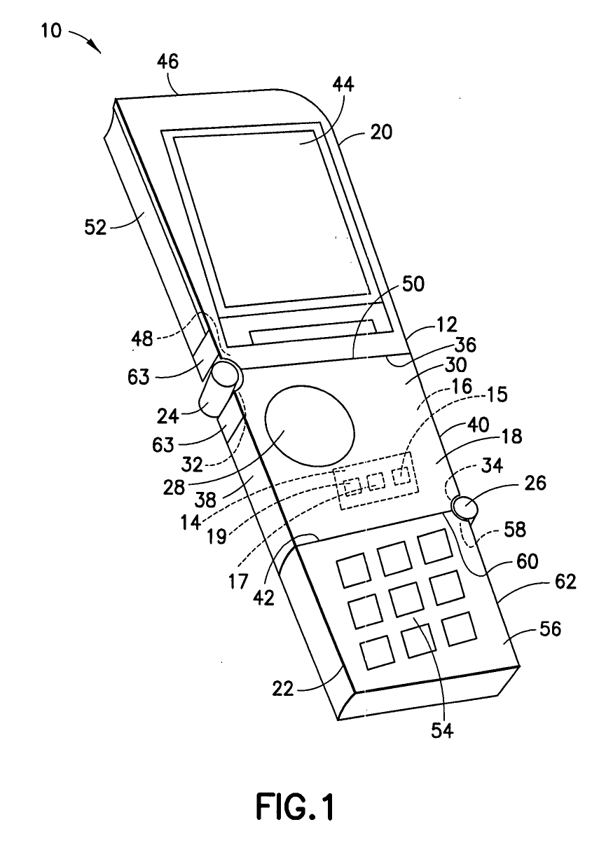

Referring to FIG. 1, there is shown a perspective view of a portable electronic device 10 incorporating features of the exemplary embodiment of this invention. Although the invention will be described with reference to the exemplary embodiments shown in the drawings, it should be understood that the invention can be embodied in many alternate forms of embodiments. In addition, any suitable size, shape or type of elements or materials could be used.

The device 10 may be a multi-function portable electronic device. The multiple functions may include, as non-limiting examples, applications such as a telephone application, a digital camera application, a video camera application, a television application, a navigation system application, a gaming application, a personal organizer or PDA application, and an internet browser application. The device 10 comprises features allowing for manipulation of the device into different use positions (or use modes) corresponding to the above mentioned applications.

FIG. 1 illustrates the device 10 in an exemplary phone mode. The device 10 generally comprises a housing 12, electronic circuitry 14 inside the housing 12, and a rechargeable battery 16 inside the housing. The electronic circuitry 14 generally comprises a controller 15, such as a microprocessor for example, a memory 17, a transceiver 19, and an antenna (not shown) However, any suitable type of electronic circuitry could be provided.

The housing 12 comprises a first housing section 18, a second housing section 20, and a third housing section 22. The housing sections, or housing assemblies, 18, 20, 22 are movably connected and are adapted to be re-oriented relative to each other into a plurality of different positions. Additionally, each of the plurality of different positions is configured to provide a different mode of use. It should be noted that although the figures illustrate the device 10 as comprising three housing sections 18, 20, 22, any number of housing sections may be provided.

The housing sections 18, 20, 22 are movably connected to each other by two vertical hinges 24, 26. The vertical hinges 24, 26 are attached to the housing 12 such that axes of rotation of the vertical hinges 24, 26 are substantially parallel to each other and allow for the housing sections 18, 20, 22 to rotate or pivot in substantially the same plane. It should be noted that although the figures illustrate the device 10 as having two vertical hinges 24, 26, alternate embodiments may provide any number or orientations of the hinges. It should further be noted that although housing sections 18, 20, 22 are shown to be movably connected to each other by the vertical hinges 24, 26, any suitable type of movable connections may be provided.

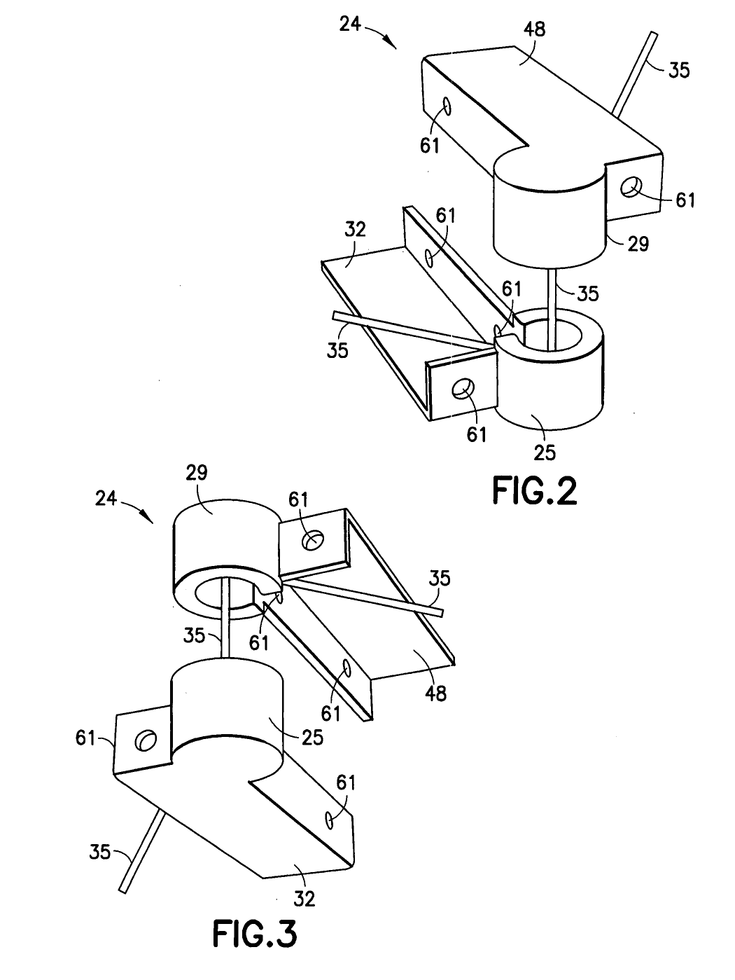

Referring now also to FIGS. 2 and 3, there are shown exploded perspective views of some of the components of the hinge 24. The hinge 24 generally comprises a first hinge portion 25 and a second hinge portion 29. The hinge 24 forms a first free end 32 and a second free end 48. In the embodiment shown the second hinge 26 is the same as the first hinge 24. However, in alternate embodiments the hinges could be different. The first hinge portion 25 is movably connected to the second hinge portion 29 allowing for rotation about a central axis of the hinge portions. The free ends 32, 48 comprise openings 61 of suitable size and shape to allow for attaching the vertical hinges 24, 26 to the housing sections 18, 20, 22. The hinges 24, 26 may be fixed or fastened to the housing sections 18, 20, 22 by any suitable fastener, such as screws for example. Additionally, the hinges 24, 26 may provide for data transmission from housing section to housing section by routing optical links or flex cables 35 through hollow portions of the hinges 24, 26. The hinge 24 shown in FIGS. 2 and 3 is merely an example of one type of hinge which could be used. Any suitable type of hinge could be provided.

The first housing section comprises a first user input region 28, which may be a joystick for example, on a front face 30 of the first housing section 18. The joystick may be adapted to be actuated by depressing and/or rotating a portion of the front face 30. However, it should be noted that any suitable joystick configuration may be provided.

First free ends 32, 34 of the vertical hinges 24, 26 are attached at opposite corners of the first housing section 18. The vertical hinge 24 is attached at the corner between a first side 36 and a fourth side 38 of the first housing section 18. The vertical hinge 26 is attached at the corner between a second side 40 and a third side 42 of the first housing section 18. The vertical hinges 24, 26 are attached to the first housing section 18 such that the axes of rotation of the vertical hinges 24, 26 are substantially perpendicular to the front face 30 (and the joystick).

The second housing section 20 comprises a display screen, or display module, 44 mounted on a front face 46 of the second housing section 20. The display screen 44 may comprise a touch screen. The display screen 44 has a generally rectangular shape and is oriented in a generally portrait orientation when the device 10 is in the phone mode (shown in FIG. 1). In this portrait position, the height of the screen 44 is larger than the width of the screen 44. However, in alternate embodiments, the display screen 44 could comprise any suitable shape.

A second free end 48 of the vertical hinge 24 is attached the second housing section 20. The vertical hinge 24 is attached at a corner between a third side 50 and a fourth side 52 of the second housing section 20. The vertical hinge 24 is attached to the second housing section 20 such that the axis of rotation of the vertical hinge 24 is substantially perpendicular to the front face 46 (and the display screen 44).

The third housing section 22 comprises a second user input region 54, which may be a keyboard or a keypad for example, on a front face 56 of the third housing section 22. The second user input region 54 may be adapted to be actuated by depressing a portion of the front face 56. The second user input region 54 may also be provided as a combined piezo sensor and piezo actuator device. The piezo sensor utilizes a piezo element to generate an electrical signal in response to physical pressure, such as the force exerted by a user's finger, so as to detect user input. The piezo actuator utilizes a similar piezo element to provide tactile feedback, such as vibration for example, to a user of the device 10. However, it should be noted that any other suitable user input configuration, such as a touch screen for example, may be provided. Additionally, the second user input region 54 may be configured to provide different layouts corresponding to the different use positions.

A second free end 58 of the vertical hinge 26 is attached the third housing section 22. The vertical hinge 26 is attached at a corner between a first side 60 and a second side 62 of the second housing section 20. The vertical hinge 26 is attached to the second housing section 20 such that the axis of rotation of the vertical hinge 26 is substantially perpendicular to the front face 56 (and the second user input region 54).

It should be noted that although the figures illustrate the first housing section 18 and the third housing section 22 comprising user input regions 28, 54 and the second housing section 20 as comprising a display screen 44, alternate embodiments may provide any combination of user input regions and display screens. For example, in one embodiment one of the housing sections may comprise a display screen and a user input region, while the other housing sections comprise either a display screen or a user input region. In another embodiment, all of the housing sections may each comprise a user input region and/or a display screen. Additionally, it should also be noted that although the figures show the user input regions 28, 54 and the display screen 44 on the front faces 30, 46, 56 of the housing sections 18, 20, 22, user input regions and display screens may be provided at any face or faces of the housing sections.

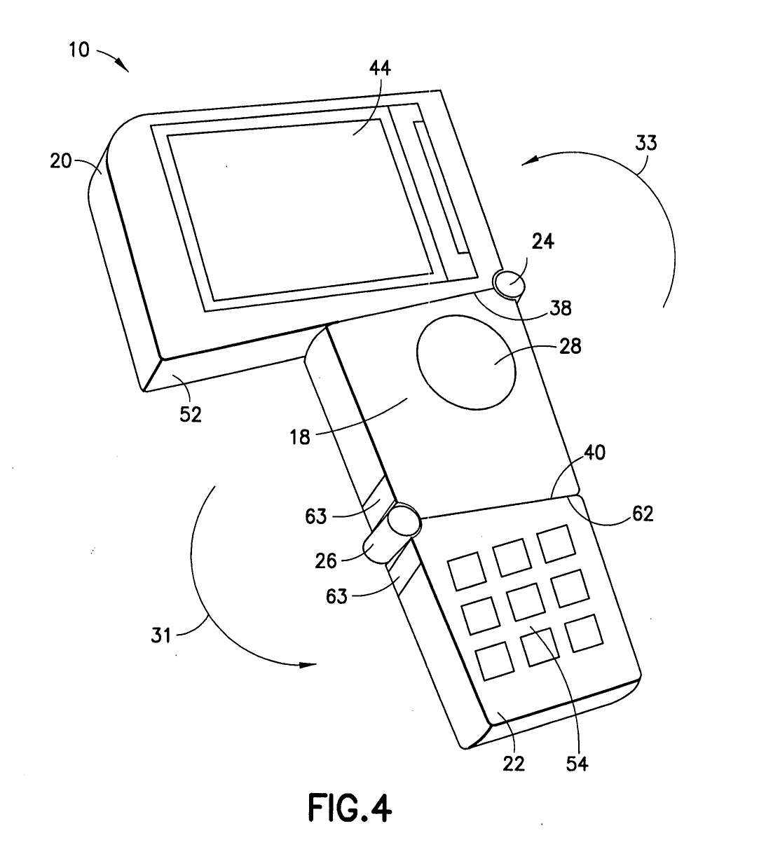

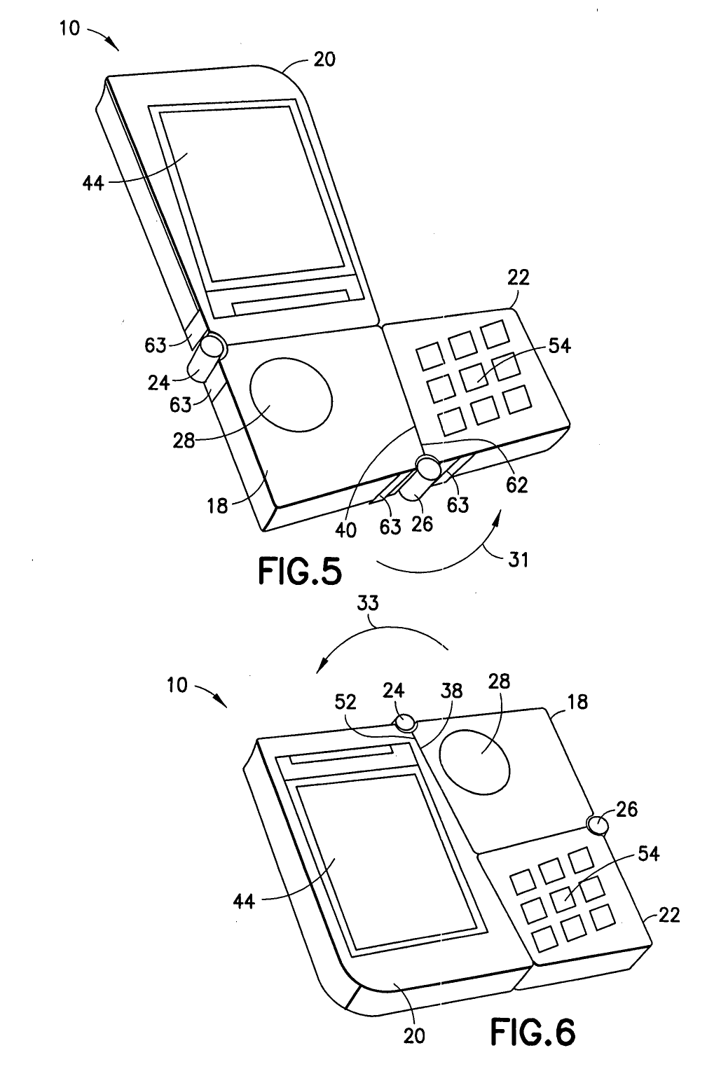

FIG. 4 illustrates the device 10 in an exemplary wide display screen mode (or ergonomic mode). The wide screen mode may provide for utilizing applications such as a digital camera application, a video camera application, a television application, and/or a navigation system application. To reconfigure the device 10 from the phone mode of FIG. 1 to the wide screen mode of FIG. 4, the third housing section 22 and the second housing section 20 are rotated about the first housing section 18. The third housing section 22 is rotated in a counter-clockwise fashion (from a first position illustrated in FIG. 1) about the vertical hinge 26 (as shown by arrow 31). The third housing section 22 is rotated to a second position (shown in FIG. 4) by aligning the second side 62 of the third housing section 22 adjacent to the second side 40 of the first housing section 18. Additionally, this orientation of the third housing section 22 rotated to the second position can also be seen in FIG. 5. The second housing section 20 is rotated in a counter-clockwise fashion (from a first position illustrated in FIG. 1) about the vertical hinge 24 (as shown by arrow 33). The second housing section 20 is rotated to a second position (shown in FIG. 4) by aligning the fourth side 52 of the second housing section 20 adjacent to the fourth side 38 of the first housing section 18. Additionally, this orientation of the second housing section 20 rotated to the second position can also be seen in FIG. 6.

It should be noted that in one embodiment the hinges 24, 26 may comprise a mechanism, such as a spring or detent mechanism for example, configured to bias the second housing section 20 and the third housing section 22 (when the particular housing section is moved) to one of their respective first or second positions. However, in another embodiment, the hinges 24, 26 may be free moving with suitable locking mechanisms on the housing sections to lock them into one of their respective first or second positions.

The housing sections 18, 20, 22 may comprise sensors 63, which may be Hall sensors for example, adapted to sense the relative orientation of the housing sections 18, 20, 22. However, any suitable sensor(s) could be provided. The sensors might be integrated into the hinges and/or separate from the hinges. For example, when the second housing section 20 is rotated from its first position to its second position, a signal from one of the sensors 63 may communicate with application software to allow the display screen 44 to change from a portrait readable orientation to a landscape readable orientation. In this landscape position, the width of the screen 44 is larger than the height of the screen 44.

As used herein, the terms “portrait” and “landscape” are used to differentiate between two different orientations of the display screen 44 when the display screen 44 has a rectangular shape. However, the display screen 44 could have other shapes and, therefore, besides the classical definitions of the terms “portrait” and “landscape” for a rectangular screen, the terms “portrait” and “landscape” are intended to indicate two different orientations for any given shape of screen. Features of the exemplary embodiments of this invention could also be used with a symmetrical screen, such as a square screen. Although “portrait” and “landscape” normally infer a 90 degree difference in orientation, the two different first and second positions could comprise more or less than a 90 degree difference in orientation.

The sensors 63 may also provide for the user input regions 28, 54 to change a layout of the keys to correspond to different use modes. For example, when the third housing section 22 is rotated from its first position to its second position, a signal from one of the sensors 63 may communicate with application software to allow the second user input region 54 to change a layout of the keyboard or keypad to correspond to the particular mode. When the device 10 is reconfigured from the phone mode to the widescreen mode, the layout of the keys of the second user input region 54 may change to allow for operation in a 180-degree rotated configuration.

The software can be stored in a program storage device readable by a machine, tangibly embodying a program of instructions executable by the machine for performing operations to operate in one of at least four modes based on reconfiguration of the housing, the operations comprising assigning different operating modes to different configurations of the housing 12; sensing the configuration of the housing 12; enabling a display 44 and user inputs 28, 54 to operate in accordance to the operating mode; and changing from one of at least four operating modes to another one of the at least four operating modes in response to reconfiguration of the housing 12.

FIG. 5 illustrates the device 10 in an exemplary game mode. To reconfigure the device 10 from the phone mode of FIG. 1 to the game mode of FIG. 5, the third housing section 22 is rotated about the first housing section 18. The third housing section 22 is rotated in a counter-clockwise fashion (from a first position illustrated in FIG. 1) about the vertical hinge 26 (as shown by arrow 31). The third housing section 22 is rotated to the second position by aligning the second side 62 of the third housing section 22 adjacent to the second side 40 of the first housing section 18.

As described above for the wide screen mode, the configuration of the user input regions 28, 54 may be changed to correspond to the game mode configuration.

FIG. 6 illustrates the device 10 in an exemplary fourth mode, which may be a music player mode or a PDA mode for example. To reconfigure the device 10 from the phone mode of FIG. 1 to the fourth mode of FIG. 6, the second housing section 2.0 is rotated about the first housing section 18. The second housing section 20 is rotated in a counter-clockwise fashion (from the first position illustrated in FIG. 1) about the vertical hinge 24 (as shown by arrow 33). The second housing section 20 is rotated to the second position by aligning the fourth side 52 of the second housing section 20 adjacent to the fourth side 38 of the first housing section 18.

As described above for the wide screen mode, the configuration of the user input regions 28, 54 may be changed to correspond to the fourth mode configuration.

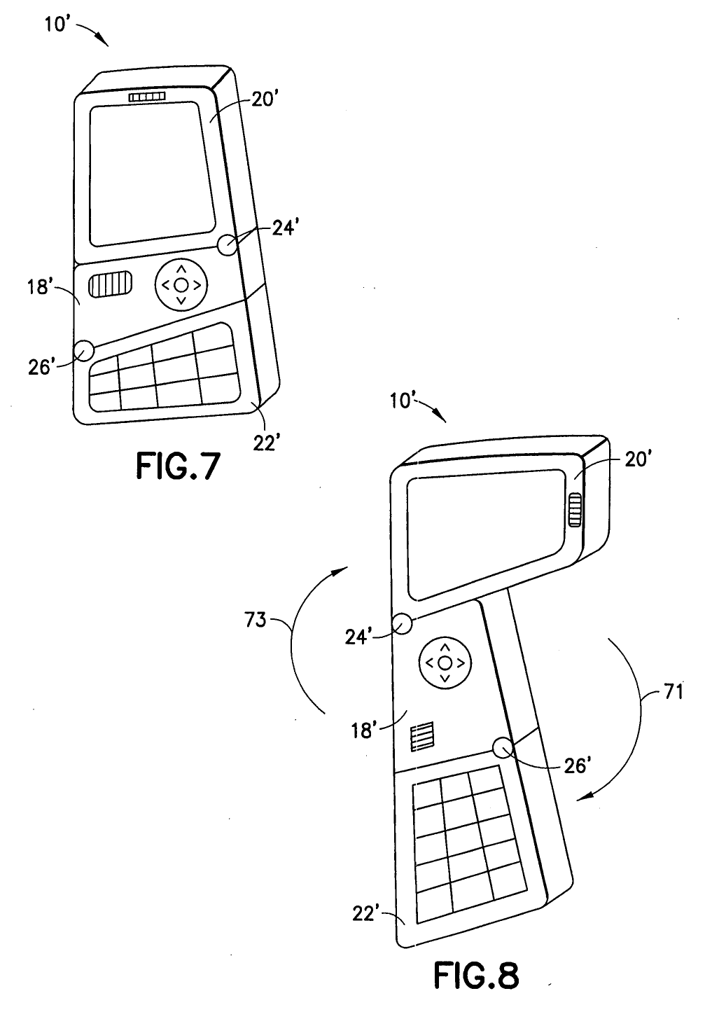

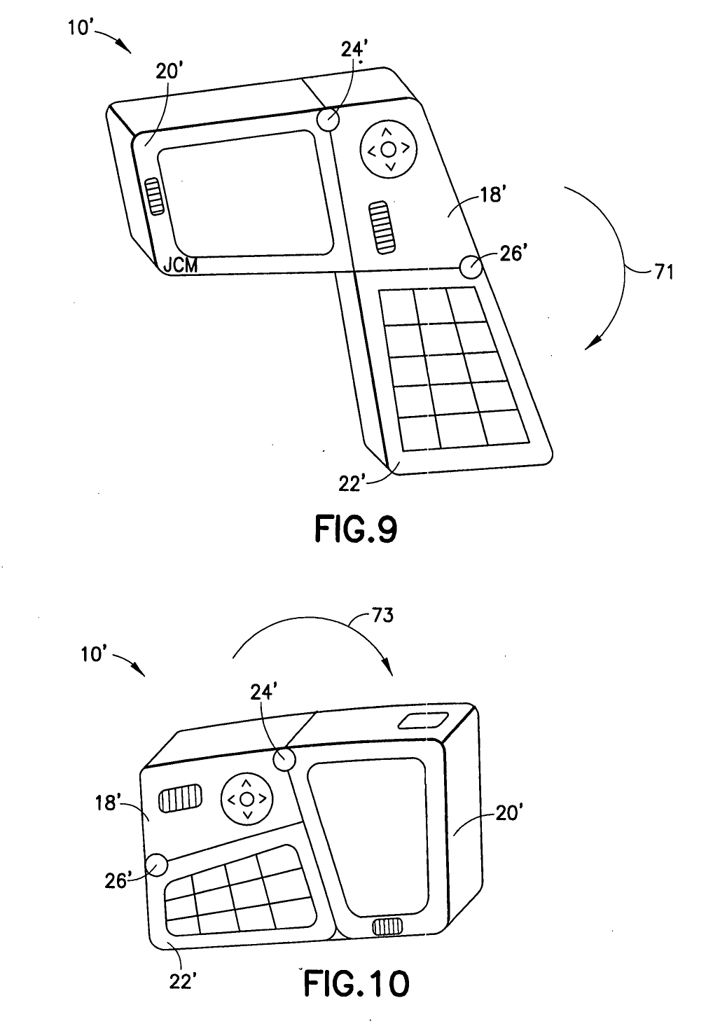

It should be noted that although FIGS. 1 and 4-6 illustrate the vertical hinge 24 attached at the corner between the first side 36 and the fourth side 38 of the first housing section 18 and the vertical hinge 26 attached at the corner between the second side 40 and the third side 42 of the first housing section 18, alternate embodiments may comprise vertical hinges at any suitable location. For example, FIGS. 7-9 illustrate a device 10′ comprising vertical hinges 24′, 26′ at opposite corners of the first housing 20′. Similar to the modes above for the device 10, FIG. 7 illustrates an exemplary phone mode. FIG. 8 illustrates an exemplary wide display screen mode. FIG. 9 illustrates an exemplary game mode. FIG. 10 illustrates an exemplary fourth mode. The housing sections 18′, 20′, 22′ of the device 10′ may be reconfigured from one mode to another mode in a similar fashion to that of device 10′ above, but in generally reverse rotation directions (clockwise) 71, 73 to that of the rotation directions 31, 33 described above for the device 10.

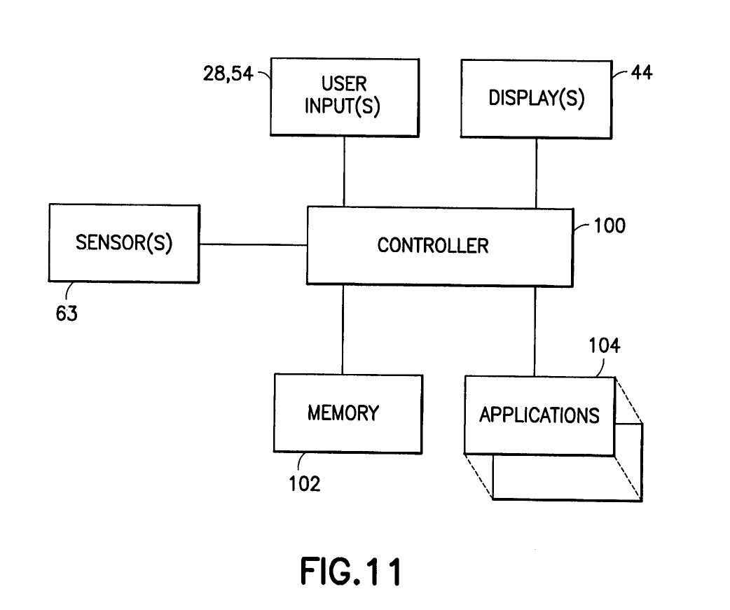

Referring now also to FIG. 11, the devices 10, 10′ generally comprise a controller 100 such as a microprocessor for example. The electronic circuitry includes a memory 102 coupled to the controller 100, such as on a printed circuit board for example. The memory could include multiple memories including removable memory modules for example. The device has applications 104, such as software, which the user can use. The applications can include, for example, a telephone application, an Internet browsing application, a game playing application, a digital camera application, etc. These are only some examples and should not be considered as limiting. One or more user inputs 28, 54 are coupled to the controller and one or more displays 44 are coupled to the controller. The sensors 63 are also coupled to the controller 100. The device 10, 10′ are preferably programmed to automatically change applications when the sensors signal a change in configuration of the housing sections. However, in an alternate embodiment, this might not be automatic. The user might need to actively select a change in the application being used/run.

It should be understood that the foregoing description is only illustrative of the exemplary embodiment of this invention. Various alternatives and modifications can be devised by those skilled in the art without departing from the invention. Accordingly, the exemplary embodiments of this invention are intended to embrace all such alternatives, modifications and variances which fall within the scope of the appended claims.

What is claimed is:

1. A portable electronic device comprising:
a housing comprising a plurality of housing sections; and
electronic circuitry mounted in the housing, wherein the plurality of housing sections are adapted to be re-oriented relative to each other into at least four different positions, and wherein each of the at least four different positions is adapted to provide a different mode of use of the device.

2. The portable electronic device of claim 1 wherein the plurality of housing sections are movably connected to each other.

3. The portable electronic device of claim 1 wherein the plurality of housing sections are connected to each other by at least one vertical hinge.

4. The portable electronic device of claim 1 wherein a first one of the plurality of housing sections comprises a first user input region, wherein a second one of the plurality of housing sections comprises a display screen region, and wherein a third one of the plurality of housing sections comprises a second user input region.

5. The portable electronic device of claim 4 wherein the display screen is configured to be readable in a portrait orientation when the plurality of housing sections are oriented into a first one of the at least four different positions, and wherein the display screen is configured to be readable in a landscape orientation when the plurality of housing sections are oriented into a second one of the at least four different positions.

6. The portable electronic device of claim 4 wherein at least one of the user input regions comprises an arrangement of user keys having at least two layouts, and wherein each of the at least two layouts correspond to one of the different modes of use.

7. The portable electronic device of claim 1 wherein a first mode of use is a phone mode, wherein a second mode of use is a wide display screen mode, wherein a third mode of use is a game mode, and wherein a fourth mode of use is a personal organizer mode/music player mode.

8. A device housing comprising:
a first housing assembly;
a second housing assembly pivotably connected to the first housing assembly; and
a third housing assembly pivotably connected to the first housing assembly;
wherein the housing assemblies are pivotable about parallel axes, and wherein the housing assemblies are pivotable into at least four different use orientations.

9. The device housing of claim 8 further comprising vertical hinges pivotably connecting the second housing assembly to the first housing assembly and pivotably connecting the third housing assembly to the first housing assembly.

10. The device housing of claim 9 wherein the first housing assembly, the second housing assembly, and the third housing assembly are configured to rotate about the vertical hinges in substantially the same plane.

11. The device housing of claim 9 wherein a first one of the vertical hinges is disposed at a first corner of the first housing, and wherein a second one of the vertical hinges is disposed at second corner of the first housing.

12. The device housing of claim 11 wherein the first corner is opposite the second corner.

13. A portable electronic device comprising:
a device housing as in claim 8; and
electronic circuitry mounted within the housing.

14. A portable electronic device comprising:
a first housing assembly comprising electronic circuitry;
a second housing assembly movably connected to the first housing assembly by a first hinge, wherein the second housing assembly is movable about the first housing assembly between a first use position and a second use position relative to the first and the second housing assemblies; and
a third housing assembly movably connected to the first housing assembly by a second hinge, wherein the third housing assembly is movable about the first housing assembly between a first use position and a second use position relative to the first and the third housing assemblies.

15. The portable electronic device of claim 14 wherein the first hinge is a vertical hinge, and wherein the second hinge is a vertical hinge.

16. The portable electronic device of claim 14 wherein at least one of the first, the second, and the third housing assemblies comprises a display screen, and wherein at least two of the first, the second, and the third housing assemblies comprises user input regions.

17. The portable electronic device of claim 14 wherein the second housing assembly comprises a display screen, wherein the display screen is in a portrait orientation when the second housing assembly is in the first use position relative to the first and the second housing assemblies, and wherein the display screen is in the portrait orientation or in a landscape orientation when the second housing assembly is in the second use position relative to the first and the second housing assemblies.

18. The portable electronic device of claim 14 wherein the first housing assembly comprises a first user input region, wherein the second housing assembly comprises a display screen, wherein the third housing assembly comprises a second user input region, and wherein the first input region, the display screen, and the second input region are in substantially the same plane.

19. A portable electronic device comprising:
a housing comprising a first housing section, a second housing section, and a third housing section; and
electronic circuitry mounted in the housing;
wherein the first housing section comprises a first side, a second side, a third side, and a fourth side;
wherein the portable electronic device is configured to operate in a first use mode when the second housing section is adjacent to the first side and the third housing section is adjacent to the third side;
wherein the portable electronic device is configured to operate in a second use mode when the second housing section is adjacent to the fourth side and the third housing section is adjacent to the second side;
wherein the portable electronic device is configured to operate in a third use mode when the second housing section is adjacent to the first side and the third housing section is adjacent to the second side; and
wherein the portable electronic device is configured to operate in a fourth use mode when the second housing section is adjacent to the fourth side and the third housing section is adjacent to the third side.

20. The portable electronic device of claim 19 wherein the first housing section, the second housing section, and the third housing section are movably connected to each other.

21. The portable electronic device of claim 19 further comprising vertical hinges pivotably connecting the second housing section to the first housing section and pivotably connecting the third housing section to the first housing section.

22. The portable electronic device of claim 21 wherein at least one of the housing sections comprises a user input region, and wherein axes of rotation of the vertical hinges are perpendicular to the user input region.

23. The portable electronic device of claim 21 wherein at least one of the housing sections comprises a display screen, and wherein axes of rotation of the vertical hinges are perpendicular to the display screen.

24. The portable electronic device of claim 19 wherein the first use mode is a phone mode, wherein the second use mode is a wide screen mode, wherein the third use mode is a game mode, and wherein the fourth use mode is a personal organizer mode.

25. A method of manufacturing a portable electronic device, the method comprising:
providing a first housing section;
attaching a first vertical hinge to the first housing section;
attaching a second vertical hinge to the first housing section;
attaching a second housing section to the first housing section at the first vertical hinge;
attaching a third housing section to the first housing section at the second vertical hinge; and
installing electronic circuitry within at least one of the housing sections.

26. The method of claim 25 wherein the attaching of the first vertical hinge further comprises attaching the first vertical hinge at a corner of the first housing and wherein the attaching of the second vertical hinge further comprises attaching the second vertical hinge at an opposite corner of the first housing.

27. A program storage device readable by a machine, tangibly embodying a program of instructions executable by the machine for performing operations to operate in one of at least four modes based on reconfiguration of the housing, the operations comprising:
assigning different operating modes to different configurations of the housing;
sensing the configuration of the housing;
enabling a display and user inputs to operate in accordance to the operating mode; and
changing from one of at least four operating modes to another one of the at least four operating modes in response to reconfiguration of the housing.
